(19) United States
(12) Patent Application Publication
(10) Pub. No.: US 2026/0266777 A1
(43) Pub. Date: Sep. 10, 2026

(54) FLAME-BASED DETECTORS WITH IGNITION PROMOTER PORT

(71) Applicant: Agilent Technologies, Inc., Santa Clara, CA (US)

(72) Inventors: Fei-Peng GUO, Shanghai (CN); Wei-Jun YAO, Shanghai (CN); Ting ZHANG, Shanghai (CN); Kaike ZHU, Shanghai (CN)

(73) Assignee: Agilent Technologies, Inc., Santa Clara, CA (US)

(21) Appl. No.: 19/166,847

(22) PCT Filed: Mar. 20, 2023
(86) PCT No.: PCT/CN2023/082506

§ 371 Date: Sep. 18, 2025

(51) Int. Cl. G01N 30/68; F23D 14/46; F23Q 9/00

(52) U.S. Cl. CPC G01N 30/68; F23D 14/46; F23Q 9/00; F23D 2207/00

(57) ABSTRACT

A flame-based detector (102) comprises a housing (104), a burner (106), a fuel flow path (108), an air flow path (110), a collector (114), an ignitor (116), an ignition promoter port (122), and an exhaust vent (128). The ignition promoter port (122) introduces a gas close to the ignitor (116), thereby facilitating combustion.

### CROSS-REFERENCE TO RELATED APPLICATIONS

None.

### FIELD OF THE INVENTION

The present invention relates generally to flame-based detectors and methods of manufacturing and using such detectors.

### BACKGROUND OF THE INVENTION

Flame-based detectors are used for the detection of analytes of a sample that are present in a fluid stream. Two such detectors are the flame ionization detector (FID) and the flame photometric detector (FPD).

Flame ionization detectors operate by burning the analytes to be analyzed so as to form ions. When used with a chromatography analytical instrument, the sample analytes eluting from a separation column are mixed with a flammable gas such as hydrogen and passed through a burner. Air is also introduced at the periphery of the burner, and upon the burner being ignited, a stable flame is formed by combustion of the fuel and air which continues to be supplied to the burner. An electrode or other ion collector is positioned downstream from the burner so as to collect the ions formed in the flame. A meter is connected with the ion collector to measure changes in current produced by the ions contacting the ion collector. The generation of these ions is proportional to the concentration of organic species in the sample introduced to the FID.

Flame photometric detectors operate in a fashion similar to that of the flame ionization detector, but rely on chemiluminescent reactions of analytes rather than ionization reactions. Typically, a FPD is used to detect the presence of sulfur or phosphorus in a sample. Like the FID, the FPD mixes a sample with a flammable fuel and air in a flame, and analytes like sulfur and phosphorus are transformed into light emitting species when burned in the flame. Rather than collecting ions, the FPD collects light emitted by the analytes as they luminesce in the flame. A photomultiplier is positioned in the FPD to collect light (photons) emitted as the analytes burn in the flame, and the light emission from the excited chemical species can be used to determine analyte concentration and to quantify the concentration of a particular excited species. FPDs often incorporate a photomultiplier tube (PMT) to measure the number of photons and thus the intensity of light emitted from phosphorus and sulfur containing compounds, with wavelength selective filters disposed between the flame of the FPD and the PMT.

U.S. Pat. No. 4,346,055 discloses a flame-ionization detector in which the ignitor is mounted above a collector body that is downstream from the jet. When the hydrogen-air gas reaches the hot filament at a suitable concentration, it is ignited. However, a disadvantage of that device is that the FID exhaust gas can contain corrosive substances such as sulfide from analyzed sample, and the exhaust gas can corrode the ignitor or parts thereof (such as its filament), and such corrosion makes it more difficult to ignite the burner.

An example of a current method for igniting a flame-based detector comprises closing the channel that provides make-up gas to the detector; opening the hydrogen channel; and opening the air channel. Ignition of the burner may be complicated by various conditions of the device or the procedure. Furthermore, the operator is typically unaware of all the conditions that are present during the attempt at ignition, thus compounding the difficulty. If the device itself is in a marginal or unsuitable condition for ignition, the operator typically must make repeated attempts at ignition before successful ignition occurs and does so without knowledge of the reason why ignition is not successful, and therefore the ignition procedure can be significantly longer and more difficult than is desirable.

This can be even more bothersome during an attempt to re-ignite a detector during a flame-out condition that has arisen during an ongoing operation of the chromatograph. For example, the loss of a flame during an analytical run requires an immediate reignition in order to achieve a quick resumption of the operation of the detector. Otherwise, the results from a significant amount of the analytical run will be compromised or lost. There is a need to increase the reliability and ease of igniting the flame of a flame-based detector. There is also a need to reduce maintenance and increase the life of such detectors.

### SUMMARY OF THE INVENTION

As one aspect of the present invention, flame-based detectors are provided. The flame-based detector comprises a housing, a burner disposed within the upstream region of the housing, a fuel flow path for providing a flammable fuel to the burner; an air flow path for providing air to the burner; and an ion collector or a photon collector. The flame-based detector also comprises an ignitor in the downstream region of the housing, and an ignition promoter port near the ignitor and configured to direct an ignition promoter gas at the ignitor.

As another aspect, detector systems are provided comprising a flame-based detector as described herein, a meter configured for measuring a signal from the collector, and a controller in signal communication with one or more other components of the detector system.

As yet another aspect, methods of igniting a flame-based detector are provided. The method comprises feeding fuel and air to the detector so that the fuel and the air flow to the ignitor; flowing an ignition promoter gas toward the ignitor of the detector; and igniting a flame in the flame-based detector.

These and other features and advantages of the present devices and methods will be apparent from the following detailed description, in conjunction with the appended claims.

### BRIEF DESCRIPTION OF THE DRAWINGS

FIG. 1 is a cross-sectional drawing of a representative embodiment of the present flame-based detector.

FIG. 2 is a diagram of a representative embodiment of a detector system comprising the present flame-based detector.

FIGS. 3A and 3B illustrate an embodiment of the present flame-based detector having an ignition promoter port in fluidic communication with an ignition promoter gas conduit.

The present teachings are best understood from the following detailed description when read with the accompanying drawing figures. The features are not necessarily drawn to scale. Wherever practical, like reference numerals refer to like features.

### DETAILED DESCRIPTION

The present flame-based detectors comprise an ignition promoter port mounted on a housing and configured to blow ignition promoter gas onto the ignitor. The ignition promoter port can intermittently blow a gas into the ignitor, thereby increasing contact area between the hydrogen-air mixture gas and the hot filament. By increasing the contact area between hydrogen-air mixture gas and the hot filament, the heat from the ignitor can ignite the mixture gas, when the ignitor (e.g., a filament) is mildly corroded and/or deformed. The present flame-based detectors provide several advantages, such improved probability of successful ignition and/or improved ignition success rate over essentially the whole life of the detector. Further, the life of the ignitor can be extended since ignition can be reliably and/or quickly achieved in spite of corrosion or deformation, which can reduce the frequency of ignitor maintenance and/or replacement.

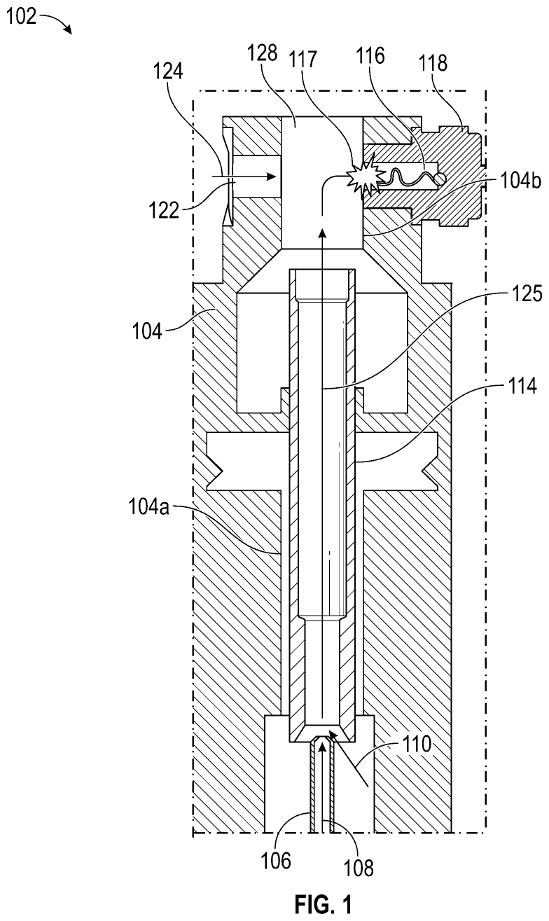

FIG. 1 shows a cross-section of an embodiment of the present flame-based detectors. More particular, FIG. 1 shows an exemplary flame ionization detector (FID) 102 though it will be understood that the flame photometric detector (FPD) can comprise many of the same components. The flame ionization detector comprises a housing 104 having an upstream region 104a and a downstream region 104b. The housing 104 can comprise one or more parts, such as two or more tubes in a fluid-tight connection. Suitable materials for the housing include stainless steel, titanium or other metals, metal alloys, ceramics, or combinations thereof.

The present flame-based detectors also comprise a burner 106 disposed within the upstream region of the housing. The burner can be made of a single unitary piece of material or from an assembly of burner components. The burner may be manufactured by machining, 3D printing, or cast molding. The material that may be used to manufacture the burner may be any metal, alloy, or polymer that is resistant to wear and may withstand high temperatures, such as a temperature of from about 200° C. to about 1000° C. For instance, the material may be a high-performance alloy with elements such as chromium, manganese, nickel, copper, titanium, molybdenum, silicon, columbium, tantalum, carbon, phosphorus, sulfur, nitrogen, iron, or a combination thereof. For example, the high-performance alloy may be a NITRONIC alloy commercially available from HP Alloys in Tipton, Ind.

The present flame-based detectors comprise a fuel flow path 108 for providing a flammable fuel to the burner. In most cases, the sample also flows through the fuel flow path 108 after exiting the column during an analysis, and it is contemplated that the fuel flow path is not limited to being a flow path only for fuel. The fuel can be hydrogen or a mixture of hydrogen and a diluent. The fuel flow path 108 can be integral with the burner 106, as shown in FIG. 1, or it may be a separate component. The present flame-based detectors comprise an air flow path 110 for providing air to the burner. The air flow path 110 can also be integral with the burner 106, or it may be a separate component. Air and fuel mix at the burner 106 to provide a flame.

The present flame-based detectors comprise a signal collector within the housing and extending from the upstream region to the downstream region. The signal collector may be an ion collector 114 in a FID or a photon collector in a FPD. Ion collectors are typically positioned adjacent to the flame generated by ignition of the air and fuel mixture at the burner. The ion collector can include one or more polarized electrodes which collect the ions produced as the sample passes through the flame. Collection of the ions causes an ionization current to flow. The current is proportional to the rate at which carbon atoms enter the flame and is therefore a measure of the concentration of hydrocarbons in the sample. The ion collector is electrically coupled to circuitry which extends through the housing, so that a signal can be transmitted. Information related to these concentrations may be stored for further analysis or output on a display device such as a gauge.

In some embodiments, the FID comprises a pair of positive and negative electrodes that are used to provide a potential difference in the FID. Typically, the burner acts as a positive electrode, and the negative electrode is the collector positioned above the flame. The ions thus are attracted to the collector and upon hitting the collector, induce a current which can be measured. The current measured corresponds roughly to the proportion of reduced carbon atoms in the flame. The response of the detector is determined by the number of carbon atoms (ions) hitting the detector per unit time. This makes the detector sensitive to the mass rather than the concentration, which is useful because the response of the detector is not greatly affected by changes in the carrier gas flow rate.

In some embodiments, the ion collector is made from stainless steel, titanium, tungsten, palladium, platinum or combinations thereof. The ion collector can have any suitable size or shape, including but not limited to tubes, cylinders, plates, or others.

Flame based detectors typically include an ignitor which is used for initial ignition and re-ignition of the flame. The present flame-based detectors comprise an ignitor 116 in the downstream region 104b of the housing. The ignitor 116 can be any of a variety of ignitors that are able to cause combustion of the combustible fuel supplied to the burner. In some embodiments, the ignitor comprises a filament such as a NiCr wire which can be heated to a temperature sufficient to ignite the fuel/air mixture. The filament can be electrically connected to a power supply which may be the same or different than the power supply for other components of the detector. The ignitor can be within the housing, or it may be within an ignitor fitting 118 attached to the housing 104.

Typically, a filament or other ignitor is mounted in the housing 104 downstream from the burner. As the hydrogen emerges in the burner, it starts mixing with air that is normally introduced around its periphery. When the gases reach the hot filament at the downstream region of the housing, they are combusted. Generally, the normal amount of gas flow is such that the resulting flame front is unable to propagate with sufficient speed to move upstream toward the burner. Therefore, the flow of one or more of the gases is reduced. When the air-to-hydrogen ratio is sufficiently reduced, the flame front propagates at a sufficiently greater speed to move upstream in the slower moving gases and ignite the burner. At this point, the flow of air or other gas is increased to a rate desired for analysis and operation of the flame-based detector. Once the burner is lit, the flame generally remains in position, but should it flame out for any reason, the process is repeated.

Flame photometric detectors are ignited in a fashion similar to that of the flame ionization detector. However, because an FPD uses a flame that is substantially enriched with hydrogen rather than air, ignition in an FPD is typically aided by increasing the air flow, while the hydrogen flow is held constant, to prevent an explosion when the flame is ignited.

In the present flame-based detectors, when a user wishes to ignite a flame at the burner 106 of the detector 102, hydrogen or other fuel is flowed into the housing through the fuel flow path, usually reaching a desired level in seconds. Then air is flowed into the housing. After passing through the collector 114, the fuel-air mixture 125 will flow to the ignitor 116 of the detector 102. When the ignitor 116 is sufficiently hot and a sufficient amount of the fuel-air mixture 125 contacts it, a blast 117 occurs from combustion of the fuel-air mixture 125, which can then travel to the burner 106.

In some embodiments, the present flame-based detectors comprise an ignition promoter port 122. As illustrated in FIG. 1, the ignition promoter port 122 is disposed in the housing 104 of the detector 102, spaced and positioned relative to the ignitor 116 so to supply a gas which promotes ignition of a fuel/air mixture by the ignitor. When ignition is desired, the combustible fuel is flowed through the burner. Air is flowed as well, and as the air flow is slowly increased, the concentration of hydrogen and air reaches a range that the fuel/air mixture is easily ignited, though less easily if the ignitor is corroded or deformed. When the concentration is in that range, the ignition promoter gas can blow the fuel/air mixture gas into the ignitor, to contact the hot filament as much as possible. The ignition promoter port 122 is opened, and an ignition promoter gas 124 flows into the housing 104. In some embodiments, the ignition promoter gas is flowed while a fuel/air mixture is fed to the detector; for instance, the ignition promoter port can be opened and the ignition promoter gas can begin flowing into the housing. After a desired period, the air flow is changed to a certain value that users set and the ignition promoter port is closed. In some embodiments, the ignition promoter gas is flowed continuously, or before the fuel/air mixture being fed to the detector. For instance, the ignition promoter gas 124 can be flowed into the housing 104 before the fuel/air mixture is fed to the detector and/or before ignition is desired. In such embodiments, the ignition promoter gas 124 can be flowed at a pressure and/or flow rate desired to promote ignition, or it can be flowed at a reduced pressure and/or flow rate, which is then increased when ignition is desired. The reduced pressure and/or flow rate of the ignition promoter gas 124 can be achieved by partially closing the ignition promoter port 122 or a valve fluidically connected to the ignition promoter port 122.

The ignition promoter gas can be fuel and/or air, or it can be another gas that is also combusted, or it can be another gas that is not combusted but promotes ignition by pushing the fuel and/or air toward the ignitor. The ignition promoter gas blows the fuel/air mixture toward the ignitor and/or increases the amount or percentage of the fuel/air mixture that contacts the ignitor.

The ignition promoter port can have any suitable size or shape. In some embodiments, the ignition promoter port is circular or oval, and the diameter or longest dimension of the ignition promoter port is from about 0.3 mm to about 1.0 mm. In some embodiments, the pressure of the ignition promoter gas is from about 5 psi to about 80 psi, though the pressure may be increased or decreased based on the pressure of the fuel/air mixture or other considerations. In some embodiments, the flow rate of the ignition promoter gas is at least about 18 ml/min, or at least about 24 ml/min or at least about 36 ml/min; alternatively about 180 ml/min or less, or about 135 ml/min or less, or about 90 ml/min or less. It is contemplated that any of the foregoing minima and maxima can be combined to form a range. It is contemplated that the flow rates may be increased or decreased based on the flow of the exhaust gas or other considerations.

In some embodiments, the ignition promoter port 122 is directly across from the ignitor 116; or downstream or upstream of the ignitor, for example, from about 1 mm to about 25 mm upstream or downstream. The ignition promoter gas can flow directly toward the ignitor, or at an angle. The ignitor and the ignition promoter port can be located on sides of the housing which face each other (for instance, where the housing has a substantially circular interior, the ignitor can be positioned at 0° and the ignition promoter port can be at about 180°, or about 90°, or about 135°, or between about 165° and about 195°, or at other degrees, around the housing's interior). In some embodiments, the flame-based detector comprises one, two, three, four or more ignition promoter ports; where a plurality of ignition promoter ports are present, they can be positioned evenly around the interior of the housing (for example, at about 90°, about 180°, and about 270°), or they may be positioned unevenly.

The ignition promoter gas can be any gas, preferably a non-combustible gas. In some embodiments, the ignition promoter gas is air. In such embodiments, the ignition promoter gas port can be fluidically connected to the same, or to a different, supply of air as the burner. In some embodiments, the ignition promoter gas is air, carbon dioxide (CO₂), nitrogen (N₂), argon (Ar), xenon (Xe), nitrous oxide (N₂O), helium (He), hydrogen (H) or a chlorofluorocarbon (CFC), and the ignition promoter port can be fluidically connected to a source of such gases.

The ignition promoter port can be configured to promote laminar flow of the ignition promoter gas towards the ignitor. The flame-based detectors can also comprise other features for forming or assisting in formation of the ignition promoter gas stream. In some embodiments, the flame-based detectors comprise one or more baffles adjacent to the ignition promoter port. The baffles can be positioned to direct or shape the flow of the ignition promoter gas exiting the port and/or to confine or re-direct the ignition promoter gas towards the ignitor.

In some embodiments, the present flame-based detectors comprise an exhaust vent 128 at the downstream region 104b of the housing 104 for exhaust gas to leave the housing 104. The exhaust vent 128 can comprise an aperture that permits exhaust gas to flow out of the housing, or it may comprise one or more components such as valves, seals, fittings, or adaptors. In some embodiments, the exhaust vent 128 comprises a flame arrestor, which may be press fit into an aperture in the downstream region of the housing. Typical flame arrestors have sufficient heat conduction to remove heat from the flame as it attempts to travel through narrow passages. The detectors can also comprise an exhaust fitting which facilitates connection of a conduit or other vessel for collecting the exhaust gas.

### Detector Systems

As another aspect, the present disclosure provides detector systems comprising the present flame-based detectors and one or more connected components. For example, a detector system can comprise a controller operably connected to a flame-based detector so as to control flow of the sample, the combustible fuel and/or the air, such as by operation of one or more valves between the respective gas supplies and the flame-based detector. The detector systems can further comprise valves, flow regulators, conduits and other components between the respective gas supplies and the flame-based detector. As an example, an embodiment of a detector system comprises various gas sources, fluid delivery components, a power source and/or voltage differential source, as well as various meters and sensors. As used herein, gas sources include containers (such as cannisters or tanks) filled with the gas, which may be pressurized or unpressurized. For example, a fuel source can be a tank of pressurized hydrogen gas. Gas sources also include panels connected to a gas distribution system such as those typically found in laboratories. The sample source will generally be or comprise a flow path from a chromatography column.

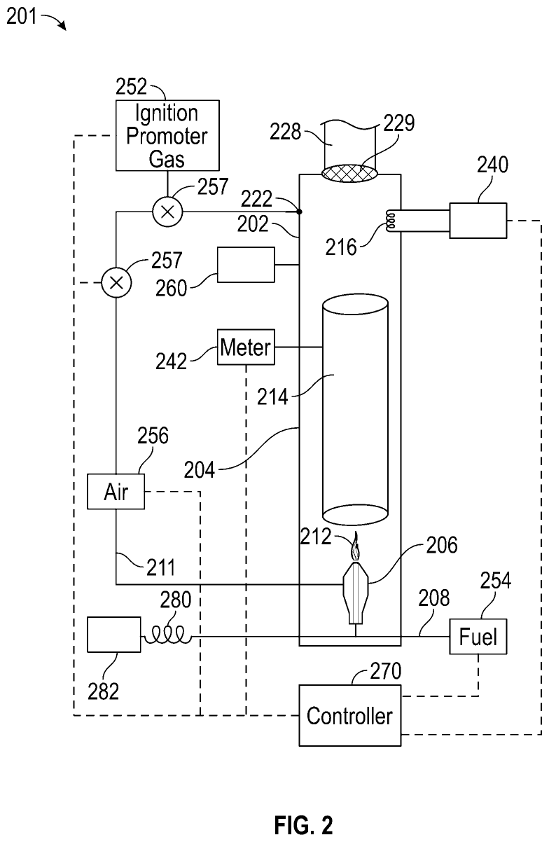

FIG. 2 illustrates an embodiment of a detector system 201 comprising a flame-based detector 202 comprising a housing 204, a burner 206, and an ion collector 214. A fuel supply conduit 208 provides a flammable fuel from fuel source 254 to the burner 206, and an air supply conduit 211 provides air from air source 256 to the burner 206. A flame 212 is ignited over a burner 206, and ions pass through ion collector 214, which is electrically connected to a meter 242 (such as a high-impedance picoammeter) capable of measuring ions collected by collector 214, by one or more electrical contacts which extend through housing 204. Exhaust gas from the collector can be discharged from the housing 204 through exhaust vent 228 and optional flame arrestor 229.

An ignitor 216 is mounted on an interior wall of housing 204 (alternatively it can be located in a recess/fitting as shown and described in FIG. 1). The ignitor 216 is electrically connected to a current source 240 so that an electrical current can be provided to ignitor 216 when it is desired to heat it to a combustion temperature. The detector system can also comprise a controller 270 in signal communication with one or more other components of the detector system.

Ignition promoter port 222 is fluidically connected to an ignition promoter gas source 252, with an ignition promoter gas valve 257 which can be operated to start, stop, increase or decrease flow of the ignition promoter gas. In the embodiment shown in FIG. 2, the ignition promoter port 222 can receive air from air source 256 and/or an ignition promoter gas from 252 by operation of ignition promoter gas valve 257.

It is also contemplated that air from air source 256 is employed as the ignition promoter gas; that is, the same air source 256 which provides air to burner 206 also provides air to ignition promoter port 222, and as a consequence, the detector system need not include a separate ignition promoter gas source. Alternatively, where detector system 201 includes an ignition promoter gas source 252, the air source 257 for the burner 206 need not be fluidically connected to ignition promoter port 222. The ignition promoter gas source 252 in such embodiments may be air or another gas. In embodiments where the ignition promoter gas is not air, the ignition promoter gas source 252 can contain carbon dioxide (CO₂), nitrogen (N₂), argon (Ar), xenon (Xe), nitrous oxide (N₂O), helium (He), hydrogen (H) or a chlorofluorocarbon (CFC). In some embodiments, the detector system comprises a make-up gas supply, and the make-up gas is also used as the ignition promoter gas; in such embodiments, the make-up gas supply is fluidically connected to the ignition promoter port.

Controller 270 can be one or more computing devices, for example, a computer such as a personal computer, and can include one or more types of hardware, firmware and/or software, as well as one or more memories and databases. Controller 270 is in signal communication with other systems, devices, or components of the detector system 201 (as partially represented, for example, by dashed lines in FIG. 2). More particularly, in FIG. 2, controller 270 is in signal communication with meter 242, ignition promoter source 252 or ignition promoter valve 257, and current supply 240. Controller 270 is also in signal communication with air source 256, fuel source 254, or with valves connected to and controlling flow from such sources. In some embodiments, controller 270 can be in communication with additional components or fewer components.

The detector system can comprise a source of flammable fuel 254, a source of air 256, eluted sample(s) from chromatographic columns, a metering system, and a variety of other components. Each gas source comprises a metering system that can meter each of hydrogen 254, air 256 and/or eluted sample(s) into specific amounts prior to providing the mixture to burner 206. Additionally, metering system can also combine the metered hydrogen, air and/or eluted sample(s) into specific mixtures prior to delivering the samples to burner 206. For example, metering system can meter and combine hydrogen 254 with the eluted sample(s) prior to providing the mixture to burner 206.

Controller 270 can be configured to receive data from the meter 242 and determine the concentration of ions as well as analytes in the sample based on the data. The manner in which the analyte is displayed can be selected by the manufacturer or user of the detector system 201, though often a graph is displayed that has time on the x-axis and detector response on the y-axis.

In some embodiments, the present flame-based detectors or detector systems are included in an analytical instrument, such as a chromatography analytical instrument. For example, the detector system 201 can be fluidically connected to a gas chromatography column 280. The chromatography analytical instrument can further comprise other chromatography components such as a sample injector 282, or an oven surrounding the chromatography column.

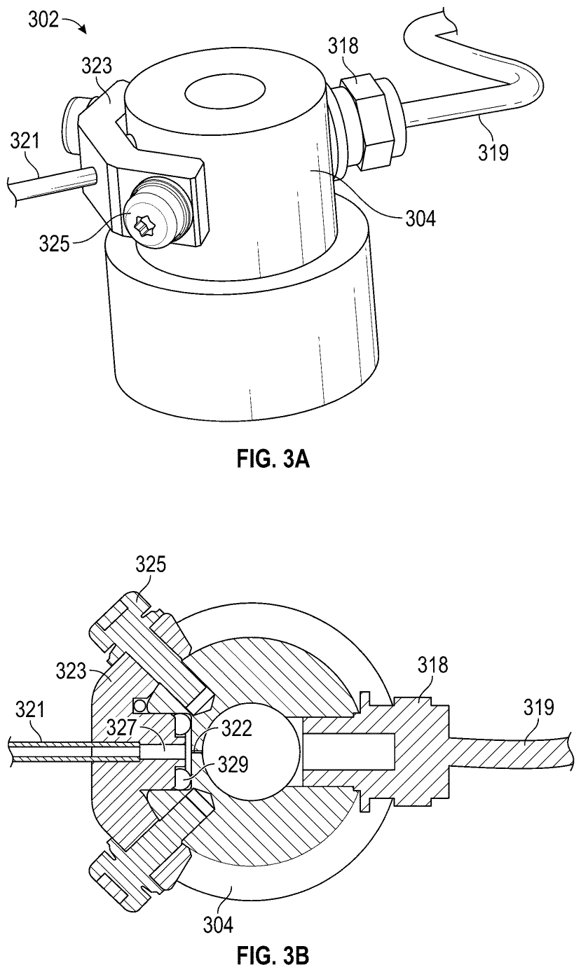

FIGS. 3A and 3B illustrate an embodiment of the present flame-based detector 302 having an ignition promoter port 322 in fluidic communication with an ignition promoter gas conduit 321. More particularly, an ignition promoter fitting 323 is attached by fasteners 325 to housing 304, though other clamps or attachment means could be used. The ignition promoter fitting 323 has one or more bores which provide a flow path and/or receive a conduit. As shown in FIG. 3B, the ignition promoter fitting 321 comprises a central bore 327 that receives the ignition promoter gas conduit 321. Alternatively, the conduit 321 could be directly attached to 304 by brazing, welding, etc. and eliminate the need for fitting 323.

FIG. 3B also shows that a sealing material 329 can be positioned at an end of fitting 323 so that a fluid-tight seal is formed where bore 327 flows ignition promoter gas into ignition promoter port 322. The detector 302 also comprises an ignitor fitting 318 inserted into housing 304 and connected to a port or current line 319.

### Methods of Igniting a Flame-based Detector

As another aspect of the present invention, methods of igniting a flame-based detector are provided, which facilitate ignition of the burner. The methods can comprise feeding fuel and air to the detector so that the fuel and the air flow to the ignitor; flowing an ignition promoter gas toward the ignitor of the detector; and igniting a flame in the flame-based detector. In some embodiments, the ignition promoter gas of the flame-based detector is flowed and stopped for one or more cycles during the ignition period. For example, the cycles comprise flowing the ignition promoter gas for about 0.05 second to about 0.1, or 0.3, or 0.5 second, and stopping the ignition promoter gas for about 0.5 second to about 1, or 3, or 5 seconds. The cycles can be stopped when the burner is ignited, at the completion of the current cycle or by interrupting the current cycle. The present methods can also comprise providing air to the detector through the air flow path, and slowly increasing flow of air to the detector. In some embodiments, the method comprises stopping the flow of the ignition promoter gas, such as by closing the ignition promoter port, after the air increase period, immediately or within seconds after the end of the air increase period.

### Defined Terms

It is to be understood that the terminology used herein is for purposes of describing particular embodiments only and is not intended to be limiting. The defined terms are in addition to the technical and scientific meanings of the defined terms as commonly understood and accepted in the technical field of the present teachings.

The term “connected” means that two components are fluidically connected, or physically connected, or both. The term “fluidically connected” means that two components are in fluid communication and includes direct connections between the two components as well as indirect connections where one or more other components are in the flow path between the two components. For example, a first component and a second component are fluidically connected if an outlet from the first component is physically connected to an inlet of the second component, or if a conduit connects the first and second components, or if one or more intervening components, such as a valve, a pump, or other structure, is between the two components as fluid flows from the first component to the second component, or vice versa. Components can be physically connected in any suitable way, such as by using ferrules, brazing, and other approaches. In general, physical connections that are fluid-tight and/or that minimize dead-volume are desired for the present devices.

Two or more systems, devices, or components are in “signal communication” when they are capable of communicating with each other via signals that travel over some type of signal path. The signal paths may include physical, electrical, magnetic, electromagnetic, electrochemical, optical, wired, or wireless connections. The signal paths may also include additional systems, devices, or components.

The term “flow path” generally refers to any structure configured to provide for fluid flow. The flow path may be a tube or a channel formed in a substrate. A flow path may be formed by or comprise one or more tubes or channels in fluid communication. A flow path typically has an entrance and an exit, though in some embodiments, a flow path can have multiple entrances and/or exits. The geometry of a flow path may vary widely and includes circular, rectangular, square, D-shaped, trapezoidal or other polygonal cross-sections. A flow path may comprise varying geometries (e.g., rectangular at one section and trapezoidal at another section). In some embodiments, the cross-sectional area of a flow path is substantially constant.

The term “port” encompasses any opening or structure that permits a fluid to pass, including an inlet, an outlet, a conduit, or an aperture or other opening. The term “conduit” generally encompasses any structure such as tubing that defines a flow path for fluid to travel from one point (e.g., an inlet of the conduit) to another point (e.g., an outlet of the conduit), though a conduit can deliver fluid to intermediate points as well. A conduit can be flexible, rigid, or both in some measure or portions. Typically a conduit is relatively long and/or linear and provides a flow path from one component (such as a gas source) to another component.

In some embodiments, the present detectors comprise a compliant seal material. For example, the ignition promoter fitting can have a compliant seal material at one or more openings, such as a resilient, essentially fluid impermeable material in the form of an o-ring. In some embodiments, a fitting or other component of the present detector comprises one or more recesses for receiving a compliant seal material. The compliant seal material can be any suitable shape, such as a toroidal-shaped o-ring, a gasket with a rectangular cross-section, a metallic gasket, or another type of compliant material. In some embodiments where the compliant seal material is in the form of an o-ring, the o-ring should compress by 15% to 25%, or by 20%, to create a fluid-tight seal. Alternatively, a flat or cylindrical gasket could be used as the compliant seal material instead of an o-ring, and the desired compression percentage may be different. In some embodiments, the compliant seal material can be made from various rubbers depending on the temperatures and gases used in the detectors, e.g., fluoropolymers, buna-n, EPDM or, in extreme cases, metallic with compliant over-plating. The compliant seal material may also be coated in a chemically inert coating if the material allows for it.

In the present disclosure, the terms “substantial” or “substantially” mean to within acceptable limits or degree to one having ordinary skill in the art. The terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same. When a range of values is set forth in the present disclosure, it should be understood that each intervening value, to the tenth of the unit of the lower limit, unless the context clearly dictates otherwise, between the upper and lower limits of that range is also specifically disclosed. Each smaller range between any stated value or intervening value in a stated range and any other stated or intervening value in that stated range is encompassed within the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described. All patents and publications referred to herein are expressly incorporated by reference.

As used in the specification and appended claims, the terms “a,” “an,” and “the” include both singular and plural referents, unless the context clearly dictates otherwise. Thus, for example, “a component” includes one component and plural components. The terms “first” and “second” conduits (or other “first” and “second” elements) are terms to distinguish different elements, not terms supplying a numerical limit, and a device having first and second element can also include a third, a fourth, a fifth, and so on, unless otherwise indicated.

In view of this disclosure, it is noted that the present methods can be implemented in keeping with the present teachings. Further, the various components, materials, structures and parameters are included by way of illustration and example only and not in any limiting sense. In view of this disclosure, the present teachings can be implemented in other applications and components, materials, structures and equipment to implement these applications can be determined, while remaining within the scope of the appended claims.

### EXEMPLARY EMBODIMENTS

Exemplary embodiments provided in accordance with the presently disclosed subject matter include, but are not limited to, the following:

Embodiment 1. A flame-based detector comprising: a housing having an upstream region and a downstream region; a burner disposed within the upstream region of the housing; a fuel flow path for providing a flammable fuel to the burner; an air flow path for providing air to the burner; a collector within the housing, wherein the collector is an ion collector or a photon collector; an ignitor in the downstream region; an ignition promoter port near the ignitor and configured to direct an ignition promoter gas at the ignitor; and an exhaust vent at the downstream region of the housing for discharging exhaust gas from the housing.

Embodiment 2. The flame-based detector of embodiment 1, wherein the ignitor is a filament mounted within or downstream of the collector tube.

Embodiment 3. The flame-based detector of embodiment 2, further comprising an ignitor fitting connected to the housing, and the filament is inside the ignitor fitting.

Embodiment 4. The flame-based detector of embodiment 1, further comprising an ignition promoter fitting connected to the housing.

Embodiment 5. The flame-based detector of any of embodiments 1 to 4, wherein the ignition promoter port is configured to blow the protective gas directly at the ignitor.

Embodiment 6. The flame-based detector of any of embodiments 1 to 5, wherein the ignitor and the ignition promoter port are located on sides of the housing which face each other.

Embodiment 7. The flame-based detector of any of embodiments 1 to 4, wherein the ignition promoter port is located at a distance from about 1 mm to about 25 mm from the ignitor.

Embodiment 8. The flame-based detector of any of embodiments 1 to 4, wherein the ignition promoter port is at an angle and is located at a distance from about 1 mm to about 25 mm upstream or downstream from the ignitor.

Embodiment 9. The flame-based detector of any of embodiments 1 to 8, wherein the ignition promoter port is circular or oval.

Embodiment 10. The flame-based detector of any of embodiments 1 to 9, wherein the ignition promoter port has a diameter or longest dimension from about 0.3 mm to about 1.0 mm.

Embodiment 11. The flame-based detector of any of embodiments 1 to 10,comprising a plurality of said ignition promotor ports positioned evenly around the interior of the housing.

Embodiment 12. The flame-based detector of any of embodiments 1 to 11, wherein the burner comprises a nozzle for forming a jet comprising fuel and air.

Embodiment 13. The flame-based detector of any of embodiments 1 to 12, wherein the collector is an ion collector.

Embodiment 14. The flame-based detector of any of embodiments 1 to 12, wherein the collector is a photon collector.

Embodiment 15. The flame-based detector of embodiment 14, wherein the flame-based detector comprises a photomultiplier tube (PMT).

Embodiment 16. A detector system comprising a flame-based detector according to any of embodiments 1 to 15, and a meter configured for measuring a signal from the collector, and a controller in signal communication with one or more other components of the detector system.

Embodiment 17. The detector system of embodiment 16, further comprising a flammable fuel source fluidically connected to the fuel flow path, and an air source fluidically connected to the fuel flow path.

Embodiment 18. The detector system of embodiment 16 or embodiment 17, wherein the air source is fluidically connected to the ignition promoter port.

Embodiment 19. The detector system of any of embodiments 16 to 18, further comprising an ignition promoter gas source fluidically connected to the ignition promoter port.

Embodiment 20. The detector system of any of embodiments 16 to 19, further comprising an ignition promoter gas valve in signal communication with the controller and fluidically connected to the air source and/or the ignition promoter gas source.

Embodiment 21. A method of igniting a flame-based detector according to any of embodiments 1 to 15, the method comprising: feeding fuel and air to the detector so that the fuel and the air flow to the ignitor; flowing an ignition promoter gas toward the ignitor of the detector; and igniting a flame in the flame-based detector.

Embodiment 22. The method of embodiment 21, wherein the method comprises flowing the ignition promoter gas intermittently during an ignition period.

Embodiment 23. The method of embodiment 22, wherein the ignition promoter gas is flowed and stopped for one or more cycles during the ignition period, wherein the cycles comprise flowing the ignition promoter gas for about 0.05 seconds to about 0.3 seconds, and stopping the ignition promoter gas for about 0.5 seconds to about 3 seconds.

Embodiment 24. The method of any of embodiments 21 to 23, wherein the method comprises increasing flow of air to the detector over an air increase period, and stopping the flow of the ignition promoter gas essentially immediately after the end of the air increase period.

Embodiment 25. The method of any of embodiments 21 to 24, wherein the ignition promotor gas is flowed through the ignition promoter port at a flow rate from about 18 ml/min to about 90 ml/min.

Embodiment 26. The method of any of embodiments 21 to 25, wherein the ignition promotor gas is selected from the group consisting of carbon dioxide (CO₂), nitrogen (N₂), argon (Ar), xenon (Xe), nitrous oxide (N₂O), helium (He), hydrogen (H), chlorofluorocarbon (CFC), and mixtures thereof.

The foregoing descriptions of exemplary or preferred embodiments should be taken as illustrating, rather than as limiting the present invention as defined by the embodiments. As will be readily appreciated, numerous variations and combinations of the features set forth above can be utilized without departing from the present invention as set forth in the embodiments.

Such variations are not regarded as a departure from the scope of the invention, and all such variations are intended to be included within the scope of the following embodiments. All references cited herein are incorporated by reference in their entireties.

We claim:

1. A flame-based detector comprising:
a housing having an upstream region and a downstream region;
a burner disposed within the upstream region of the housing;
a fuel flow path for providing a flammable fuel to the burner;
an air flow path for providing air to the burner;
a collector within the housing, wherein the collector is an ion collector or a photon collector;
an ignitor in the downstream region;
an ignition promoter port near the ignitor and configured to direct an ignition promoter gas at the ignitor; and
an exhaust vent at the downstream region of the housing for discharging exhaust gas from the housing.

2. The flame-based detector of claim 1, wherein the ignitor is a filament mounted within or downstream of the collector tube.

3. The flame-based detector of claim 2, further comprising an ignitor fitting connected to the housing, and the filament is inside the ignitor fitting.

4. The flame-based detector of claim 1, further comprising an ignition promoter fitting connected to the housing.

5. The flame-based detector of claim 1, wherein the ignition promoter port is configured to blow the ignition promoter gas directly at the ignitor.

6. The flame-based detector of claim 1, wherein the ignitor and the ignition promoter port are located on sides of the housing which face each other.

7. The flame-based detector of claim 1, wherein the ignition promoter port is located at a distance from about 1mm to about 25mm upstream or downstream from the ignitor.

8. The flame-based detector of claim 1, wherein the ignition promoter port is at an angle relative to the ignitor orientation and is located at a distance from about 1mm to about 25mm upstream or downstream from the ignitor.

9. The flame-based detector of claim 1, wherein the ignition promoter port has a diameter or longest dimension from about 0.3mm to about 1.0mm.

10. The flame-based detector of claim 1, comprising a plurality of said ignition promotor ports positioned around the interior of the housing.

11. The flame-based detector of claim 1, wherein the burner comprises a nozzle for forming a jet comprising fuel and air.

12. The flame-based detector of claim 1, wherein the collector is an ion collector.

13. The flame-based detector of claim 1, wherein the collector is a photon collector.

14. The flame-based detector of claim 13, wherein the flame-based detector comprises a photomultiplier tube (PMT).

15. A detector system comprising a flame-based detector according to claim 1, and a meter configured for measuring a signal from the collector, and a controller in signal communication with one or more other components of the detector system.

16. The detector system of claim 15, further comprising a flammable fuel source fluidically connected to the fuel flow path, and an air source fluidically connected to the fuel flow path.

17. The detector system of claim 15, wherein the air source is fluidically connected to the ignition promoter port.

18. The detector system of claim 15, further comprising an ignition promoter gas source fluidically connected to the ignition promoter port.

19. The detector system of claim 15, further comprising an ignition promoter gas valve in signal communication with the controller and fluidically connected to the air source and/or the ignition promoter gas source.

20. A method of igniting a flame-based detector according to claim 1, the method comprising:
feeding fuel and air to the detector so that the fuel and the air flow to the ignitor;
flowing an ignition promoter gas toward the ignitor of the detector; and
igniting a flame in the flame-based detector.
